(19) United States
(12) Patent Application Publication
(10) Pub. No.: US 2007/0246095 A1
(43) Pub. Date: Oct. 25, 2007

(54) Apparatus for generating electrical power from solar radiation concentrated by a concave reflector

(75) Inventor: Guenter Schaefer, Coconut Creek, FL (US)

Correspondence Address: RONALD V. DAVIDGE, SUITE 514, 3300 UNIVERSITY DRIVE, CORAL SPRINGS, FL, 33065, US

(73) Assignee: Hydrogain Technologies, Inc.

(21) Appl. No.: 11/407,456

(22) Filed: Apr. 20, 2006

(51) Int. Cl. H02N 6/00

(52) U.S. Cl. 136/246

(57) ABSTRACT

An electrical power generator includes a concave reflector formed to reflect light parallel to its central axis toward the central axis, on a surface of an energy receiving structure that preferably has a surface covered with photovoltaic cells facing outward from the central axis in directions perpendicular to the central axis. A cooling fluid is circulated though channels in a structure mounting the photovoltaic cells. The concave reflector is mounted to pivot about two axes of revolution, being driven by one or two motors to track the movement of the sun across the sky.

### BACKGROUND OF THE INVENTION

1. Field of the Invention

This invention relates to apparatus for generating electrical power from solar radiation, and, more particularly, to such apparatus including a reflector concentrating solar radiation on a transducer producing electrical energy, in which the reflector and the transducer are moved to follow the relative movement of the sun.

2. Summary of the Background Art

The most common method for directly converting solar energy to electricity is the photovoltaic cell, in the form of a thin, flat disk-shaped or square element that is arranged within an array of elements formed in a flat solar panel. Generally, the solar panel is not moved to maintain alignment with the sun, but is arranged in a fixed location at an angular orientation providing maximum electrical output on a basis averaged over daily and yearly operation. The electrical output of such a solar panel is naturally limited by the efficiency of the photovoltaic cells and by the total area of the photovoltaic cells exposed to the ambient level of solar radiation.

It is particularly desirable to substantially increase the electrical output of a number of solar cells above the level that can be provided with the cells merely exposed to ambient sunlight, particularly since the cost of the photovoltaic cells represents a significant portion of the total cost of providing electrical power from solar energy, and additionally because the worldwide availability of photovoltaic cells is limited. It is known that photovoltaic cells are capable of efficient operation at light levels higher than the level of ambient sunlight, so a number of patents describe means for providing individual light concentrators that focus light on the surfaces of individual photovoltaic cells within a solar panel, In such an arrangement, the individual photovoltaic cells are spaced apart from one another so that light can be collected from an area larger than the area of the individual cell on which the light is focused. Examples of such an arrangement are found in U.S. Pat. No. 4,002,031, which shows individual lenses concentrating solar energy directed to individual cells, and in U.S. Pat. No. 4,106,952, which shows a transparent sheet extending over spaced apart cells, with the sheet including a portion shaped as a concentrating lens over each cell. Another such arrangement is found in U.S. Pat. No. 4,148,298, which shows an array of photovoltaic cells, with each cell facing but toward a curved reflector serving as a collector and concentrator.

Whet is needed is an apparatus achieving a relatively high ratio of concentration of radiant energy from the sun without requiring that the individual photovoltaic cells must be spaced apart from one another. Mounting such cells close to one another provides for a more compact structure of heat receiving elements, making simple arrangements for cooling and electrical connections possible.

It is well known that a parabolic reflector reflects parallel rays to its focal point when the optical axis of its parabolic surface is aligned with the parallel rays. The patent literature includes a number of descriptions of apparatus using this principle to concentrate energy from the sun's radiation to produce heat, with the parabolic reflector being pivoted at two axes to track the movement of the sun relative to the earth. For example, such devices are described in Published International Pat. App. No. WO 2004/099682 A2 and in U.S. Pat. No. 5,275,149. As described in U.S. Pat. No. 4,198,826, in a Fresnel reflector design, the reflector surface may be divided into a number of concentric annular surfaces, each of which is shaped as a portion of a cone so that parallel light rays are reflected to a common focal point. The reflective surfaces may be further broken up into an array of mirrors individually angled so that parallel rays are directed to a common point, as described in U.S. Pat. No. 3,466,119, or reflected off one or more additional surfaces to a common point, as described in U.S. Pat. No. 4,784,700.

Since such arrangements of reflectors reflect sunlight from a relatively large area to a small area around a focal point, the levels of light and heat are higher than those required for efficient operation of photovoltaic devices over long periods of time. Thus, another arrangement, such as a circulating fluid carrying heat away from the heated area and providing for its use through a remote heat exchanger, or heating a surface of a boiler producing steam to drive an engine, is required. Thus, what is needed is an apparatus using a reflector to direct sunlight to an array of photovoltaic cells arranged with the reflector, with the area of the cells being substantially larger than the area in the vicinity of the focal point that is heated by such reflector systems of the prior art. Additionally, it is desirable to incorporate the array within the reflector, so that it is not necessary to provide a structure extending outward from the reflector to a focal point.

### SUMMARY OF THE INVENTION

In accordance with a first aspect of the invention, an electrical power generator is provided, including a concave reflector, an energy receiving structure, a stationary mounting structure, a first pivotal mounting structure, and a motor. The concave reflector has a reflective surface extending along a surface of revolution formed about a central axis, with the reflective surface reflecting light from a light source aligned with the central axis inward, toward the central axis, within the concave reflector. The energy receiving structure, which is attached to the concave reflector, extends within the concave reflector, having a photovoltaic surface facing outward from the central axis of the central axis in directions perpendicular to the central axis. The first pivotal mounting structure attaches the concave reflector to the stationary mounting structure while allowing pivotal movement with the sun during movement of the sun relative to the stationary structure.

Preferably, the photovoltaic surface of the energy receiving structure includes a plurality of photovoltaic cells attached to a cell support structure to face outward from the cell support structure, perpendicular to the central axis, with the cell support structure including a plurality of channels through which a coolant is circulated. For example, the cell support structure may include a plurality of walls with each wall including a plurality of channels extending between opposite ends, an outer manifold, an inner manifold, at least one inlet tube for a flow of cooling fluid into one of the channels, at least one outlet tube for a flow of cooling fluid outward from another one of the channels, and a number of passages for a flow of cooling fluid between the channels.

For example, the concave reflector includes an inner reflective portion an outer reflective portion extending outward from the inner reflective surface. The inner reflective surface portion extends along a first conical surface extending at a solid angle greater than ninety degrees, while the outer reflective surface portion extends along a second conical surface extending at a solid angle of ninety degrees. Preferably, a central support plate holds the energy receiving structure within the concave reflector, while a number of support ribs extending outward from the central support plate are attached to the concave reflector.

Preferably, the electrical generator additionally includes a second pivotal mounting structure, attaching the concave reflector to the stationary mounting structure while allowing pivotal movement of the concave reflector about a second axis of rotation, perpendicular to the first axis of rotation. A first version of the electrical generator also includes another motor, pivoting the concave reflector about the second axis, while a second version has the second axis extending parallel to the direction of travel of the sun relative to the earth, so that manual adjustments in rotation about the second axis can be made more infrequently to compensate for seasonal changes.

### BRIEF DESCRIPTION OF THE DRAWINGS

FIG. 1 is a vertical cross-sectional elevation of an electrical power generator built in accordance with a first embodiment of the invention;

FIG. 2 is an elevation of the generator of FIG. 1 as viewed along z central axis of a reflector therein;

FIG. 3 is a transverse cross-sectional elevation of an energy receiving structure within the generator of FIG. 1, taken as indicated by section lines 3-3 therein;

FIG. 4 is a fragmentary lateral cross-sectional elevation of the energy receiving structure of FIG. 3, taken as indicated by section lines 4-4 therein; FIG. 4 is a fragmentary lateral cross-sectional elevation of the energy receiving structure of FIG. 3, taken as indicated by section lines 4-4 therein;

FIG. 5 is a fragmentary longitudinal cross-sectional elevation of the energy receiving structure of FIG. 3, taken as indicated by section lines 5-5 therein;

FIG. 6 is a block diagram of a cooling system used in the generator of FIG. 1;

FIG. 7 is a block diagram of a reflector position control system within the generator of FIG. 1;

FIG. 8 is a flow chart showing operation of a reflector positioning program executing within the control system of FIG. 7;

FIG. 9 is a partly cut away perspective view of a solar tracking device for alternative use within the generator of FIG. 1; and

FIG. 10 is a vertical cross-sectional elevation of an electrical power generator built in accordance with a second embodiment of the invention; and

FIG. 11 is a fragmentary perspective view of an alternative reflector for use within the electrical power generator of FIG. 1 or of FIG. 10.

### DETAILED DESCRIPTION OF THE INVENTION

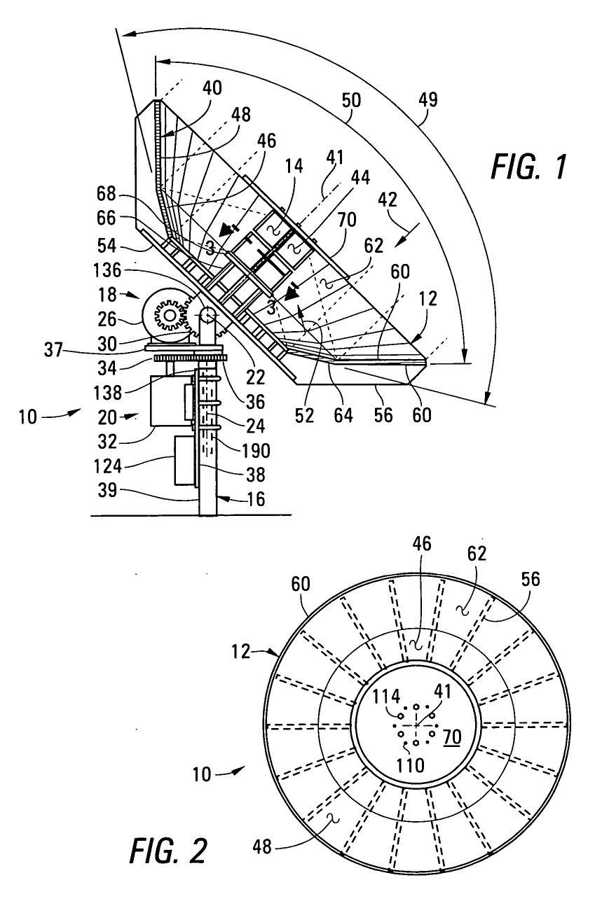

FIG. 1 is a vertical cross-sectional elevation of an electrical power generator 10 built in accordance with a first embodiment of the invention. The electrical power generator 10 includes a concave reflector 12, an energy receiving structure 14, a stationary mounting structure 16, a first pivotal mounting structure 18, and a second pivotal mounting structure 20. The pivotal mounting structures 18, 20 together attach the concave reflector 12 to the stationary mounting structure while providing an ability for the concave reflector to pivot about a first axis of rotation 22 and a second axis of rotation 24, perpendicular to the first axis of rotation 22. A first motor 26 is provided for pivoting the concave reflector 12 about the first axis of rotation 22 by rotating a drive gear 28 engaging a sector gear 30 attached to the concave reflector 12. A second motor 32 is provided for pivoting the concave reflector 12 about the second axis of rotation 24 by rotating a drive gear 34 engaging a sector gear 36 attached to an intermediate plate 37, upon which the first pivotal mounting structure 18 is mounted. The second motor 32 is in turn attached to a plate 38 clamped to a pole 39 forming part of the stationary mounting structure 16. For example, the motors 26, 32 are direct current motors that can be reversed by reversing the direction of the current flow driving the motors, with a number of speed reducing gears being incorporated within the motors 26, 32.

The concave reflector 24 has a reflective surface 40 extending along a surface of revolution formed about a central axis 41. It is understood that a surface of revolution is a surface formed by revolving a plane curve about the central axis 41, with the central axis 41 therefore being a feature of the reflective surface 40. The reflective surface 40 reflects light from a light source, such as the sun, aligned with the central axis 41, with such light traveling in the direction of arrow 42 parallel to the central axis 41, inward toward the central axis 41, within the concave reflector 12. The energy receiving structure 14, which is attached to the concave reflector 12, extends within the concave reflector 12, having a photovoltaic surface 44 facing outward from the central axis 41 in directions perpendicular to the central axis 41. A photovoltaic surface is understood to be a surface composed of a material causing a voltage to be generated when the surface is struck by incident light energy.

In the example of FIG. 1, the concave reflector 24 includes an inner reflective portion 46 and an outer reflective portion 48 extending outward from the inner reflective surface 46. The inner reflective surface portion extends along a first conical surface extending at a solid angle 49 greater than ninety degrees, while the outer reflective surface portion extends along a second conical surface extending at a solid angle 50 of ninety degrees. This arrangement reflects light traveling parallel to the central axis 41, in the direction of arrow 42, and striking the outer reflective portion 48 directly inward, perpendicular to the central axis 41 to strike the energy receiving structure 14, while such light striking the inner reflective portion 46 is reflected as indicated by arrow 52 to also strike the energy receiving structure 14.

FIG. 2 is an elevation of the electrical generator 10 as viewed along the central axis 41, in the direction of arrow 42. Referring to FIGS. 1 and 2, a central support plate 54 holds the energy receiving structure 14 within the concave reflector 12, while a number of support ribs 56 extending outward from the central support plate 54 are attached to the concave reflector 12, which is formed as a curved sheet of material 60, having a reflective surface 62 opposite the side 64 to which the support ribs 56 are attached. The curved sheet of material 60 extends between the support ribs 56. The energy receiving structure 14 is held in place on the central support plate 54 by a number of columns 66 extending between the support plate 54 and an inner plate 68 forming part of the energy receiving structure 14. The photovoltaic surface 44 of the energy receiving structure 14 extends between the inner plate 68 and an outer plate 70.

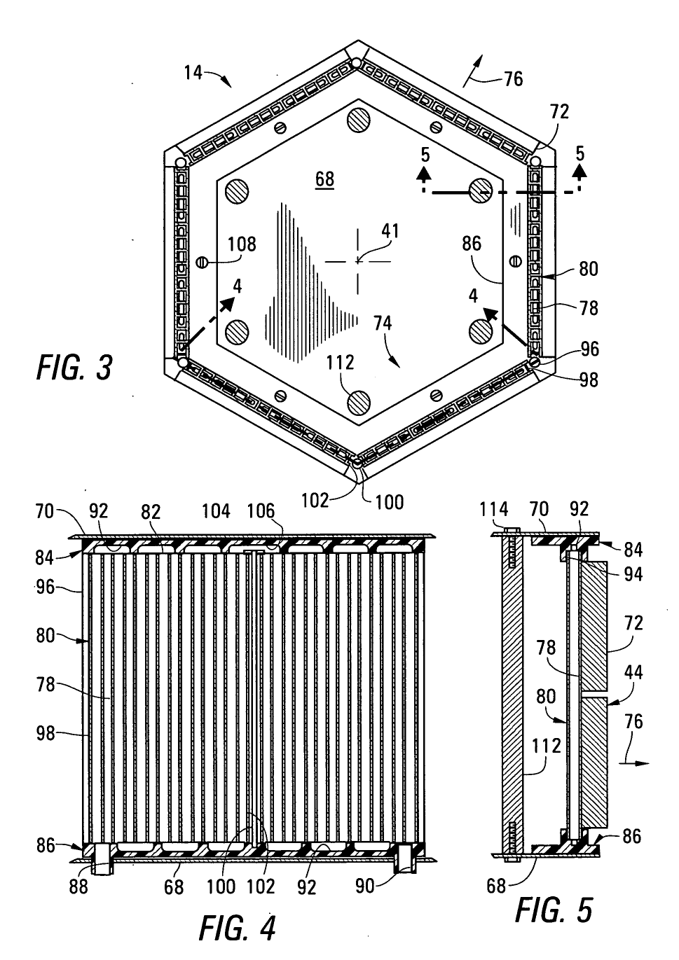

FIG. 3 is a transverse cross-sectional elevation of the energy receiving structure 14, taken as indicated by section lines 3-3 in FIG. 1. Preferably, the photovoltaic surface 44 of the energy receiving structure 14 includes a plurality of photovoltaic cells 72 attached to a cell support structure 74 to face outward from the cell support structure 74, in directions 76 perpendicular to the central axis 41, with the cell support structure 74 including a plurality of channels 78 through which a cooling fluid is circulated. For example, the photovoltaic cells 72 are conventional devices having electrical terminals (not shown) that are wired to carry electrical energy produced within the cells 72 outward from the electrical power generator 10 for use. The cell support structure 74 includes a plurality of walls 80 with each wall 80 including a plurality of the channels 78.

An exemplary version of the cell support structure 74 will now be discussed, with reference being made to FIGS. 4 and 5. FIG. 4 is a fragmentary lateral cross-sectional view of the energy receiving structure 14, taken as indicated by section lines 4-4 in FIG. 3 through a pair of adjacent walls 80. FIG. 5 is a fragmentary longitudinal cross-sectional view of the energy receiving structure 14, taken as indicated by section lines 5-5 in FIG. 3. The channels 78 extend between opposite ends 82 of each wall 80. The cell support structure 74 additionally includes an outer manifold 84, and an inner manifold 86 having inlet tubes 88 providing for a flow of cooling fluid into the channels 78, and outlet tubes 90 providing for a flow of cooling fluid outward from the channels 78. Both the outer manifold 84 and the inner manifold 86 include a number of passages 92, formed as slots within the manifolds 84, 86, providing for a flow of cooling fluid between adjacent channels 78, with the ends 82 of the walls 80 held within slots 94 of the manifolds 84, 85.

The cell support structure 74 additionally includes three alignment rods 96 extending between the manifolds 84, 86 and between wall sides 98 adjacent to the inlet and outlet tubes 88, 90 of the inner manifold 86. Three alignment rods 100 extend between wall sides 102 that are not adjacent the inlet and outlet tubes 88, 90, with each of the alignment rods 100 also extending between the inner manifold 86 and a bridge plate 104, which serves as a side of a passage 106 providing for a flow of cooling fluid between channels 78 within adjacent walls 80. The bridge plate 104 is held within the slot 94 of the outer manifold 84.

The inner manifold 85 is attached to the inner plate 68 by a number of screws 108 (shown in FIG. 3), while the outer manifold 84 is similarly attached to the outer plate 70 by a number of screws 110 (shown in FIG. 2). The plates 68, 70 are in turn held together by columns 112, which are fastened to extend between the plates 68, 70 by screws 114. Additional brackets (not shown) may be provided within the cell support structure 74 to support the walls 80, particularly in relatively large versions of the electrical power generator 10.

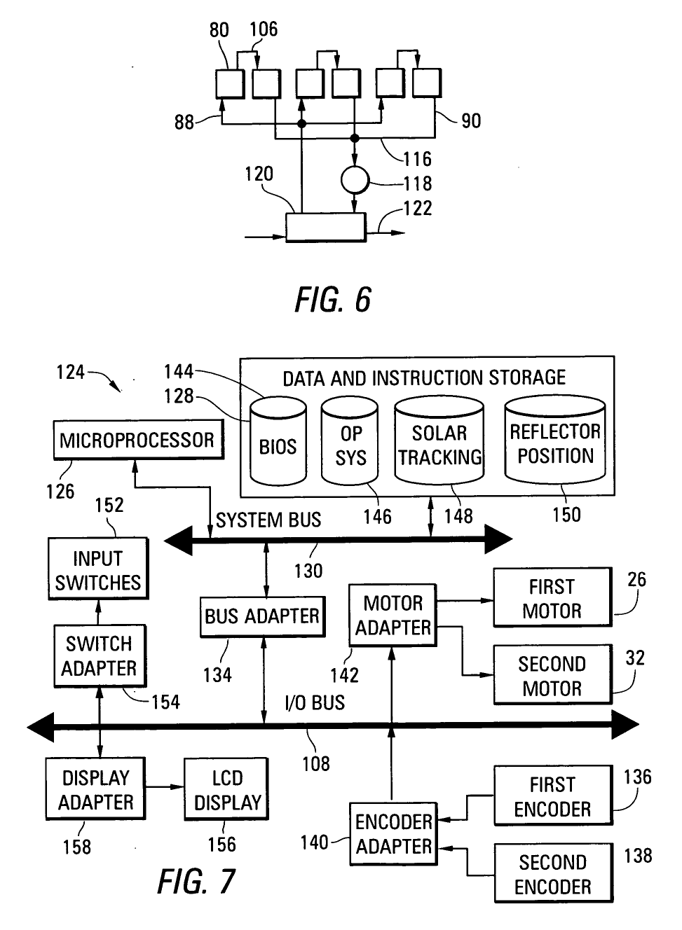

FIG. 6 is a block diagram of cooling system used for the electrical generator 10, including a conduit 116, carrying a cooling fluid circulated within the channels 78 of the walls 80. As described above in reference to FIGS. 3-5, the cooling fluid flows through passages 106 between adjacent walls 80 in pairs of the walls 80, with each of these pairs of walls 80 being provided with an inlet tube 88 and an outlet tube 90. In general, at least one inlet tube 88 and one outlet tube 90 must be provided within the arrangement. The cooling fluid is moved by a pump 118 through the channels 78, the conduit 116, and a heat exchanger 120. Another fluid may be moved through an additional conduit 122 within the heat exchanger 120, providing, for example, a hot water supply.

FIG. 7 is a block diagram of a reflector position controller 124 within the electrical power generator 10. The controller 124 includes a microprocessor 126 executing program instructions stored within data and instruction storage 128, which is connected to the microprocessor 126 for data transfer by a system bus 130. An I/O (input/output) bus 132 is also connected to the system bus 130 through a bus adapter 134. A first encoder 136 provides a first data signal indicating the rotational position of the concave reflector 12 about the first axis of rotation 22, while a second encoder 138 provides a second data signal indicating the rotational position of the concave reflector 12 about the second axis of rotation 24. The data signals from these encoders 136, 138 are processed within an encoder adapter 140 to provide signals suitable for transmission along the I/O bus 108. The microprocessor 126 provides a first drive signal for driving the first motor 26 and a second drive signal for driving the second motor 32, with these drive signals being processed within a motor adapter 142 to form suitable signals for driving the motors 26, 32.

Data and instruction storage 128 stores a BIOS (Basic Input/Output System) subroutine 144 and an operating system 146, providing for the operation of the controller 124, including the generation of a time of day clock function generating information on a real time basis indicating the time and date. This information is used within a solar tracking program 148 to develop data indicating the position of the sun relative to the stationary support structure 36 at all times during daylight hours. Mathematical functions for describing the position of the sun at all times are both reliable and well known, with solar movement being probably the first technical problem studied by mankind. The data and instruction storage 128 additionally stores a reflector positioning program 150, which determines error signals indicating differences between actual position of the concave reflector 12, as indicated by data signals from the encoders 136, 138 and the solar position calculated by the solar tracking program 148, and which provides signals for driving the motors 26, 32 to reduce the magnitude of these error signals. In this way, the concave reflector 12 is moved so that its central axis 41 remains in alignment with the sun. During nighttime, the concave reflector 12 is returned by the positioning program 150 to a morning position to begin the process of following the movement of the sun the next day.

Preferably, the controller 124 additionally includes a number of input switches 152, producing signals processed within a switch adapter 152, which are used for initializing the controller 124, with the date and time being set. A small LCD display 156 is provided for indicating the operational state of the system and the present date and time, with signals being processed within a display adapter 158.

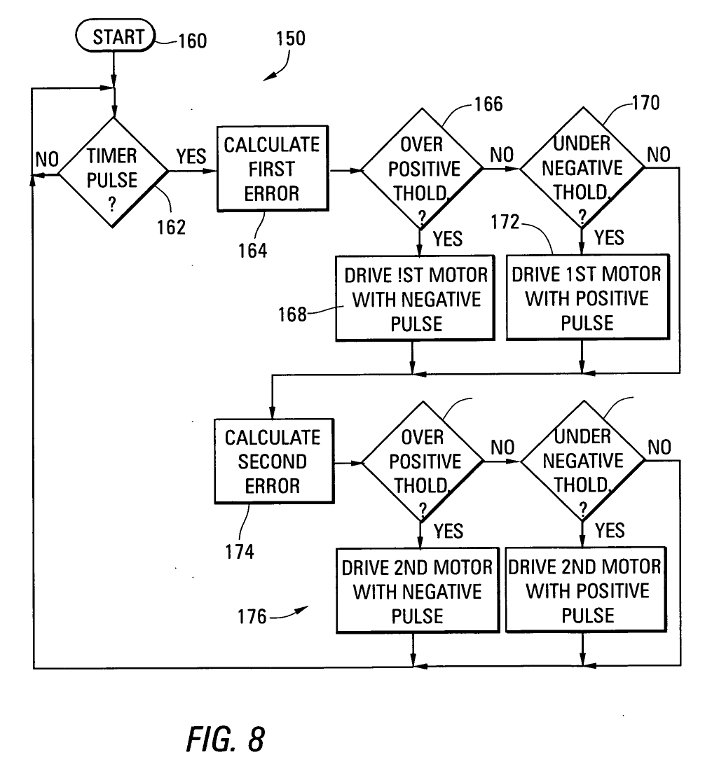

FIG. 8 is a flow chart showing operation of the reflector positioning program 150, which is started in step 160 as part of an initialization process. Various program instructions are then executed each time a timer pulse occurs, as determined in step 162, causing the first error signal to be calculated in step 164. Then, if it is determined in step 166 that the first error signal is over a positive threshold, the first motor 26 is driven with a positive pulse in step 168. Preferably, the positive pulse is of a short enough duration to prevent the first error signal from passing a negative threshold, so that hunting movements will not occur in the positioning of the concave reflector 12. Similarly, if it is determined in step 170 that the first error signal is under a negative threshold, the first motor is driven with a negative pulse in step 172. Next, the second error signal is calculated in step 174 with similar adjustments being made using the second motor 32, if necessary, in steps 176.

During daylight hours, the first and second error signals are calculated as differences between the positions indicated by the encoders 136, 138 and the position of the sun, as calculated by the solar tracking program 148, so that the concave reflector 12 is moved to align its central axis 41 with the sun. During nighttime, the first and second error signals are calculated as differences between the positions indicated by the encoders 136, 138 and a starting position into which the sun will move the next morning, so that the concave reflector 12 is moved to align its central axis 41 with this starting position.

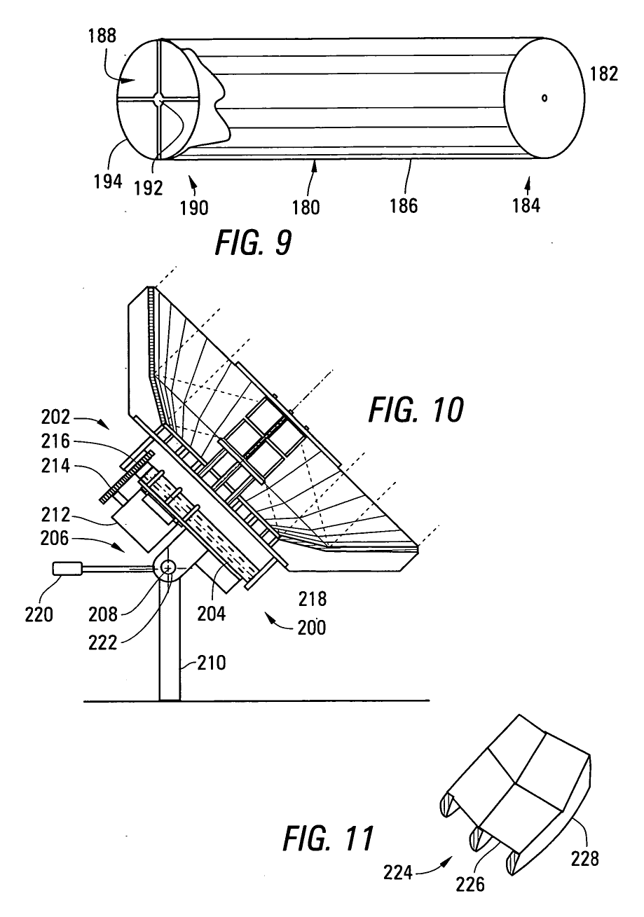

FIG. 9 is a partly cut away perspective view of a solar tracking device 180 that is alternately used to develop error signals for positioning the concave reflector 12. This solar tracking device 180 includes a small aperture 182 at an outer end 184 of an opaque cylinder 186 and a target 188 at the opposite end 190 of the cylinder 186. The target 188 includes a central area 192 that is aligned so that a line between the center of the area 192 and the center of the aperture 182 is parallel to the central axis 41 of the concave reflector 12. Four photosensitive devices 194, which may, for example, be photovoltaic or photoconductive, are placed around the central area. When the central axis 41 of the concave reflector 12 is aligned with the sun, rays from the sun strike the central area 194, so that output signals from the devices 194 remain below threshold levels. When the central axis 41 is moved out of alignment with the sun, an output signal from one or two of the devices 194 indicates the direction that the central axis 41 should be moved to regain alignment with the sun. Thus, the output signals from the photosensitive devices 188 are alternately used to develop the error signals otherwise calculated in steps 164, 174. The methods previously described for solar tracking are still required, however, for use during the night so that the concave reflector 12 can be returned to its home position, and so that the concave reflector 12 can be moved properly when the view of the sun is blocked by the passage of clouds.

In the electrical generator 10, a vertical second axis 24 was provided to allow the convenience of having a pivot shaft 190 extending within the vertical post 36. However, with this arrangement, the concave reflector 12 must be rotated about both axes 22, 24 to track the movement of the sun during a single day.

FIG. 10 is a vertical cross-sectional elevation of an alternative electrical power generator 200 built in accordance with a second embodiment of the invention to include a first pivotal mounting structure 202 to provide for pivotal movement of the concave reflector 12 about a first axis of rotation 204 and a second pivotal mounting structure 206 to provide for pivotal movement of the concave reflector about a second axis of rotation 208. Preferably, the second axis of rotation 208, which is horizontal, is aligned with the direction of daily relative movement of the sun with respect to a stationary structure 210 of the generator 200. With this arrangement, the daily relative movement of the sun is tracked merely by rotating the reflector 12 about the first axis of rotation 204, through the operation of a single motor 212, which turns a drive gear 214 engaging a sector gear 216 attached to a shaft 218 pivoting with the concave reflector 12. Rotation of the second axis of rotation 208 is required only to correct for seasonal variations, and thus is not need on a frequent basis. Therefore, a second motor and associated control devices are not provided in the example of FIG. 9, with a manual lever 220 being provided to pivot the reflector 12 about the second axis of rotation 208. For example, the manual lever 220 is driven into engagement with a stationary shaft 222 to hold the position of the reflector 12 about the second axis of rotation 208.

Alternately, the system of axes of rotation discussed above in reference to FIG. 10 may be used with a second motor (not shown) being used to rotate the reflector 12 about the second axis of rotation 208, compensating for seasonal variations in the position of the sun.

FIG. 11 is a fragmentary perspective view of an alternative reflector 224 that can be used in place of the previously-described reflector 12 in either the electrical power generator 10 or the alternative electrical power generator 200. The alternative reflector 224 is composed of a number of flat reflective elements 226 extending between support ribs 228.

The present invention is seen to provide a number of advantages over prior art systems including parabolic reflectors focusing solar radiation on a small area. Since the present invention directs solar radiation to an energy receiving structure 14 occupying a much larger area, conventional photovoltaic cells can be used to convert solar energy directly to electrical energy without overheating. Furthermore, a structure holding a heat receiving element outward from the reflector, at the focal point of a parabolic reflector, is not required. Furthermore, the fact that solar energy is directed at a much larger area means that substantial latitude is allowed for variations in the construction of the reflector and in the required accuracy of solar tracking.

While the apparatus has been described and shown in its preferred embodiments with some degree of particularity, it is understood that this description has been given only by way of example, and that many variations can be achieved without departing from the spirit and scope of the invention, as defined in the appended claims.

What is claimed is:

1. An electrical power generator comprising:
a concave reflector having a reflective surface extending along a surface of revolution formed about a central axis, wherein the reflective surface reflects light from a light source aligned with the central axis inward, toward the central axis, within the concave reflector;
an energy receiving structure attached to the concave reflector and extending within the concave reflector, wherein the energy receiving structure includes a photovoltaic surface facing outward from the central axis and perpendicular to the central axis;
a stationary mounting structure;
a first pivotal mounting structure attaching the concave reflector to the stationary mounting structure while allowing pivotal movement about a first axis of rotation;
a motor pivoting the concave reflector about the first axis to hold the central axis of the concave reflector in alignment with a sun during movement of the sun relative to the stationary structure.

2. The electrical power generator of claim 1, wherein the photovoltaic surface of the energy receiving structure includes a plurality of photovoltaic cells attached to a cell support structure to face outward from the cell support structure, perpendicular to the central axis.

3. The electrical power generator of claim 2, wherein the cell support structure includes a plurality of channels through which a coolant is circulated.

4. The electrical power generator of claim 3, additionally comprising:
a conduit connected to the plurality of channels within the cell support structure, wherein the cooling fluid is circulated through the conduit;
a pump moving the cooling fluid through the conduit; and
a heat exchanger connected to the conduit for removing heat from the cooling fluid.

5. The electrical power generator of claim 4, wherein the cell support structure includes:
a plurality of walls, with each wall including a plurality of channels extending between opposite ends;
an outer manifold extending along an outer end of the cell support structure and around an outer end of each of the walls;
an inner manifold extending along an inner end of the cell support structure and around an inner end of each of the walls;
a plurality of passages for a flow of cooling fluid between adjacent channels at the outer ends of the walls;
at least one inlet tube for a flow of cooling fluid into one of the channels at the inner end of one of the walls; and
at least one outlet tube for a flow of cooling fluid out of one of the channels at the outer end of one of the walls.

6. The electrical power generator of claim 5, wherein the cell support structure additionally includes a plurality of passages for a flow of cooling fluid between adjacent channels at the inner ends of the walls.

7. The electrical power generator of claim 6, wherein the passages for a flow of cooling fluid between adjacent channels are formed as slots within the outer manifold and the inner manifold.

8. The electrical power generator of claim 1, wherein the concave reflector includes:
an inner reflective surface portion extending along a first conical surface formed as a surface of revolution about the central axis; and
an outer reflective surface portion extending outward from the inner reflective surface portion along a second conical surface formed as a surface of revolution about the central axis.

9. The electrical power generator of claim 8, wherein
the second conical surface extends at a solid angle of ninety degrees, and
the first conical surface extends at a solid angle greater than ninety degrees.

10. The electrical power generator of claim 1, additionally comprising
a central support plate holding the energy receiving structure within the concave reflector; and
a plurality of support ribs extending radially outward from the central support plate, wherein a surface of the concave reflector opposite the reflective surface of the concave reflector is attached to the support ribs.

11. The electrical power generator of claim 10, wherein the concave reflector comprises a curved reflective member extending between the support ribs.

12. The electrical power generator of claim 10, wherein the concave reflector comprises a plurality of flat reflective elements extending between the support ribs.

13. The electrical power generator of claim 1, additionally comprising:
a second pivotal mounting structure attaching the concave reflector to the stationary mounting structure while allowing pivotal movement about a second axis of rotation, perpendicular to the first axis of rotation; and
a motor pivoting the concave reflector about the second axis of rotation to hold the central axis of the concave reflector in alignment with the sun during movement of the sun relative to the stationary structure.

14. The electrical power generator of claim 13, additionally comprising:
a first encoder producing a first signal representing movement of the central axis of the concave reflector about the first axis of rotation;
a second encoder producing a second signal representing movement of the central axis of the concave reflector about the second axis of rotation;
a controller including a microprocessor programmed to generate time of day clock information, to generate solar tracking information identifying a location of the sun relative to the stationary structure during daylight hours as a function of the time of day clock information, to generate a first error signal indicating differences between the location the central axis of the concave reflector as a function of the first signal and the location of the sun as a function of the solar tracking information, to generate a first drive signal driving the motor pivoting the concave reflector about the first axis of rotation to reduce an absolute value of the first error signal, to generate a second error signal indicating differences between the location the central axis of the concave reflector as a function of the second signal and the location of the sun as a function of the solar tracking information, and to generate a second drive signal driving the motor pivoting the concave reflector about the second axis of rotation to reduce an absolute value of the second error signal.

15. The electrical power generator of claim 14, additionally comprising an solar tracking device providing signals representing levels of deviation between the central axis of the reflector and the position of the sun, wherein the microprocessor is additionally programmed to generate the first and second error signals in response to the signals provided by the solar tracking device.

17. The electrical power generator of claim 13, wherein the first axis is vertical and the second axis is horizontal.

18. The electrical power generator of claim 1, additionally comprising a second pivotal mounting structure attaching the concave reflector to the stationary mounting structure while allowing pivotal movement about a horizontal axis of rotation, wherein the first axis or rotation is held perpendicular to the second axis of rotation.

19. The electrical power generator of claim 18, additionally comprising:
a first encoder producing a first signal representing movement of the central axis of the concave reflector about the first axis of rotation;
a controller including a microprocessor programmed to generate time of day clock information, to generate solar tracking information identifying a location of the sun relative to the stationary structure during daylight hours as a function of the time of day clock information, to generate an error signal indicating differences between the location the central axis of the concave reflector as a function of the first signal and the location of the sun as a function of the solar tracking information, to generate a drive signal driving the motor pivoting the concave reflector about the first axis of rotation to reduce an absolute value of the first error signal.

20. The electrical power generator of claim 19, additionally comprising an solar tracking device providing a signal representing levels of deviation between the central axis of the reflector and the position of the sun, wherein the microprocessor is additionally programmed to generate the first and second error signals in response to the signals provided by the solar tracking device.
